(19) United States
(12) Patent Application Publication
(10) Pub. No.: US 2009/0126865 A1
(43) Pub. Date: May 21, 2009

(54) METHOD OF MANUFACTURING A LABEL HAVING A REFLECTIVE PORTION

(75) Inventors: Robert E. Baum, Dell Rapids, SD (US); Donald P. Klein, Dell Rapids, SD (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL LABEL, INC., Sioux Falls, SD (US)

(21) Appl. No.: 11/943,006

(22) Filed: Nov. 20, 2007

(51) Int. Cl. B44C 1/165

(52) U.S. Cl. 156/230

(57) ABSTRACT

A method for manufacturing a label having a highly reflective printed ink portion. The method includes the steps of printing an ink on a carrier film, laminating the carrier film to a label film so that the ink adheres to the label firm, and removing the carrier film from the label film so that the ink remains on the label film. The exposed surface of the ink—originally formed on the carrier film—is highly reflective, especially when the ink is a metallic ink.

### BACKGROUND OF THE INVENTION

The present invention relates to methods of manufacturing labels, and more particularly to methods of manufacturing labels having reflective portions.

A wide variety of labels include reflective portions. Such labels are used for example within the consumer products field, where eye-catching, aesthetically attractive labels are desired. The reflective portions can be created by surface printing metallic ink on the label. An example of such a label is illustrated in U.S. patent application Ser. No. 11/384,578 filed Mar. 20, 2006, entitled Laminated Multi-Ply In-Mold Label. Alternatively, the reflective portions can be created by applying a hot-stamp metallic foil to the label.

The quality of the reflective portion comes at a cost. Hot-stamped metallic foils provide the best reflectivity, but they also are the highest cost. Surface-printed metallized inks are less expensive, but they are less reflective. Consequently, there is a continuing need for label constructions and manufacturing techniques that provide both high reflectivity and reasonable cost.

### SUMMARY OF THE INVENTION

The aforementioned problems are overcome in the present invention comprising a method of manufacturing labels having reflective portions. The process includes the steps of printing a reflective ink onto the carrier web, laminating the carrier web to a label web so that the printed ink adheres to the label web, and removing the carrier web from the label web so that the ink remains adhered to the label web. The exposed surface of the reflective ink in the finished label is the ink surface that originally engaged the carrier web. Consequently, the ink surface is extremely smooth and highly reflective.

The present invention provides an improved balance between reflectivity and cost. The invention enables the use of reflective inks, such as metallic ink, to achieve excellent reflectivity. Indeed, the reflectivity of the resulting label is similar to the reflectivity of a label having a hot-stamp metallic foil.

These and other objects, advantages, and features of the invention will be more fully understood and appreciated by reference to the detailed description of the preferred embodiment and the drawings.

### BRIEF DESCRIPTION OF THE DRAWINGS

FIG. 1 is a perspective view of the label on a container; and

FIG. 2 is a perspective view of the carrier web and the label web in the manufacturing method.

### DESCRIPTION OF THE CURRENT EMBODIMENT

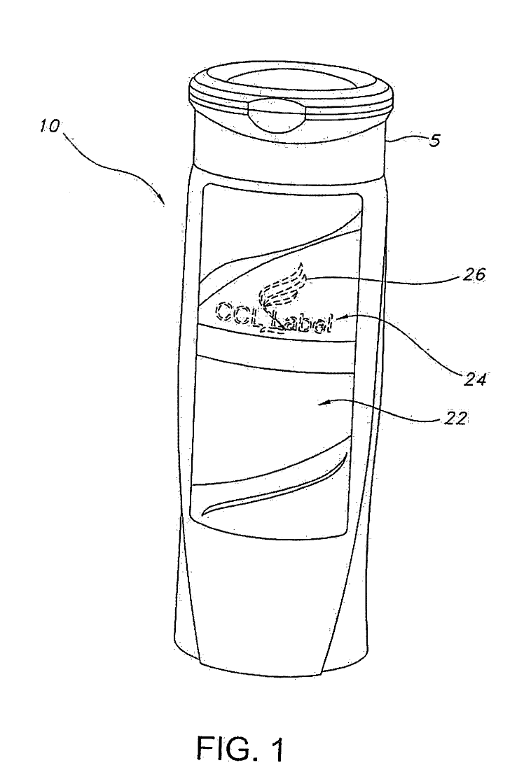

A label manufactured in accordance with the current embodiment of the method of the present invention is illustrated in FIG. 1 and generally designated 10. As illustrated, the label is applied to a container 5. However, the label is suitable for attachment to a wide variety of articles and objects. The label includes a highly reflective portion 22, a product name 24, and a logo 26. At least the highly reflective portion 22 is created using the method of the present invention. Optionally, the product name 24 and the logo 26 also can be created using the method.

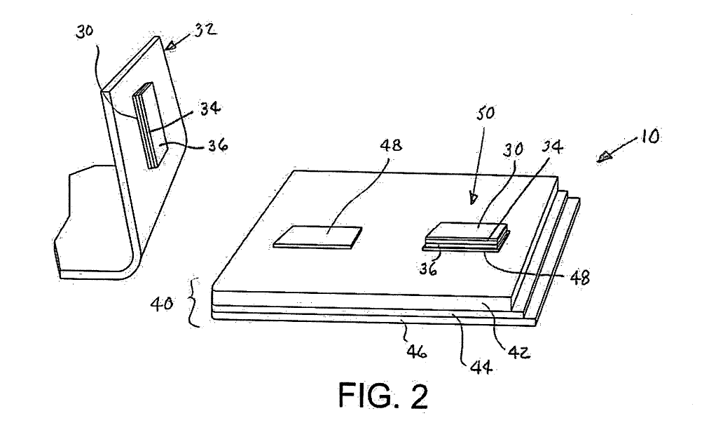

FIG. 2 illustrates the components used in the manufacture of the label 10. As the first step in the process, a reflective ink 30 is printed on a carrier film 32. The reflective ink 30 may be any appropriate ink now know or later developed. In the current embodiment, the ink 30 is that sold by XSYS Print Solutions Ltd. under the designation SP 1821. The carrier film 22 in the current embodiment is a low surface energy film such as that sold by the AmTopp Division of The Inteplast Group, Ltd. under the designation TT50. In the current embodiment, the film is a continuous web, but alternatively the film could be discrete pieces or sections.

The film 32 has a smooth surface. Consequently, when the ink 30 is printed on the film 32, the surface of the ink engaging the film also is extremely smooth. An analogy is that the ink of the film is like the silvering on a mirror.

The ink 30 can be pattern printed, or it can be printed over the entire surface of the film 32. If pattern printed, the pattern will be the reverse of the desired image in the final label. The rectangular patch of ink 30 illustrated in FIG. 2 is not necessarily representative of the pattern in any particular label.

Additional layers 34, 36 may be printed over the reflective ink 30. The layers 34, 36 may include other reflective inks, non-reflective inks, or any other inks generally known to those skilled in the art.

The label material 40 is a sandwich of plies including a base ply or film 42, a pressure sensitive adhesive layer 44 on the underside of the film, and a release liner 46. The film and adhesive are releasably adhered to the release liner. The label material 40, and particularly the film 42, may be any suitable material known to those skilled in the art, and may or may not include the adhesive 44 and the release liner 46. In the current embodiment, the label material 40 is a continuous web—for example that sold by Avery Dennison under the designation FasClear. Alternatively, the label material 40 could be discrete pieces or sections.

An adhesive 48 is printed on the upper surface of the base material 42. In the current embodiment, the adhesive 48 is pattern printed to correspond to the pattern of the printed ink 30 on the carrier ply 32. Alternatively, the adhesive may extend the full width and length of each label.

The next step in the method is that the carrier ply 32 is laminated to the label material 40. Although not shown in the drawings, the carrier film 32 is brought into contact with the base film 42 so that the pattern (if included) of the printed ink 30 is aligned with the corresponding pattern of the adhesive 48. As the films are laminated together, the printed ink 30 (including any additional inks such as 34 and 36) adhere to the adhesive 48. The resulting layer sandwich 50 includes the adhesive 48, the printed ink 30, and any other ink layers 34, 36. It is important that the adhesion between the ink 30 and the label film 42 be greater than the adhesion of the ink 30 to the carrier film 32.

The next step is that the carrier film 32 is removed from the base film 42. The carrier film 32 comes off cleanly with none of the inks 30, 34, 36 adhering to the carrier film. Rather, all of the inks 30, 34, 36 adhere to the upper surface of the label film 42. The carrier film 32 is discarded following removal. Conceivably, the carrier film could be reused in the manufacture of additional labels.

Additional optional manufacturing steps could be performed. For example, a protective overlaminate could be applied over the base film 42. Other possibilities include the printing of a protective layers over the base film 42. Other optional additional steps will be known to those skilled in the art.

The exposed surface of the ink 30 is extremely smooth and therefore highly reflective. The smoothness of the exposed surface of the ink 30 approximates the smoothness of the carrier film 32. Indeed, the reflectivity of the printed ink 30 is similar to that of currently available hot-stamp metallic foils.

The present manufacturing method produces a label having excellent aesthetics at a reasonable cost, and enables the use of highly reflective labels in a wider variety of applications, and also reduces the potential cost of the labeled products.

The above description is that of a current embodiment of the invention. Various alterations and changes can be made without departing from the spirit and broader aspects of the invention as defined in the appended claims, which are to be interpreted in accordance with the principles of patent law, including the doctrine of equivalents.

1. A method of manufacturing a label comprising:
printing a reflective ink on a carrier web in a first printed pattern;
printing an adhesive on a label web in a second printed pattern corresponding to the first printed pattern;
laminating the carrier web to the label web with the pattern printed ink adhering to the pattern printed adhesive; and
removing the carrier web from the label web leaving the pattern printed ink adhered to the pattern printed adhesive on the label web.

2. (canceled)

3. A method of manufacturing a label as defined in claim 1 wherein the ink is a metallic ink.

4. A method of manufacturing a label as defined in claim 1 wherein the carrier web is a low surface energy film.

5-9. (canceled)

10. A method of manufacturing a label comprising:
printing a metallic ink in a first pattern on a low surface energy film;
printing adhesive in a second pattern on a label film, the second pattern corresponding to the first pattern;
laminating the low surface energy film to the label film so that the metallic ink adheres to the adhesive; and
removing the low surface energy film from the label film so that the metallic ink remains adhered to the adhesive on the label film.

11. (canceled)
